(19) United States
(12) Patent Application Publication
(10) Pub. No.: US 2026/0211829 A1
(43) Pub. Date: Jul. 23, 2026

(54) SYNCHRONIZING SERIAL DRIVERS USING VIRTUAL SERIAL REGISTERS

(71) Applicant: NVIDIA Corporation, Santa Clara, CA (US)

(72) Inventor: Aki Petteri NIEMI, Vancouver (CA)

(73) Assignee: NVIDIA Corporation, Santa Clara, CA (US)

(21) Appl. No.: 19/035,333

(22) Filed: Jan. 23, 2025

(51) Int. Cl. G06F 13/40; G06F 13/38; G06F 13/42

(52) U.S. Cl. CPC G06F 13/4072; G06F 13/387; G06F 13/4282

(57) ABSTRACT

In various examples, systems and methods are disclosed relating to synchronizing serial drivers using virtual serial registers. A system can initialize a serial driver comprising a virtual register and transmit, using a first application, a first serial communication via the serial driver to configure an aggregator in communication with a plurality of components. The system can update, using the first application, the virtual register responsive to the aggregator being configured. The system can transmit, using a second application, a second serial communication to at least one of the plurality of components responsive to the virtual register having been updated.

### BACKGROUND

Serial protocols, such as inter-integrated circuit (I²C), can be used to enable communication between integrated circuits. Serial protocols can be implemented using corresponding drivers and peripheral device(s), which can decode serial signals to execute corresponding commands, such as write commands or read commands.

### SUMMARY

The present disclosure is directed to techniques for synchronizing serial drivers using virtual serial registers. In certain architectures, multiple sensors or components communicate via a serial communication protocol such as I²C through a single shared aggregator (sometimes referred to herein as a “deserializer”). The aggregator may include multiple I²C ports and can receive the serial data and can translate it into a format that is compatible with the sensors/components. Traditional approaches to managing access to the shared aggregator involve a startup sequence where one application/driver initializes the aggregator first, followed by subsequent applications/drivers after a predetermined delay or using inter-process synchronization mechanisms. These approaches introduce dependencies between application/drivers. These approaches are also impracticable to implement reliably when applications/drivers are executing in a manner that does not permit inter-process communication, such as isolated virtual machine environments or containers.

The techniques described herein address the challenge of coordinating access to a shared aggregator by implementing a serial driver that instantiates a virtual serial device including at least one virtual register. The virtual device and associated register may be accessed using a corresponding serial address in the serial device/address space. The virtual serial registers can be used to store data in a similar manner to a software semaphore, enabling synchronization between isolated applications/drivers that are to access the serial driver for device communication. In one example, a first application/driver can automatically manage the initialization of the shared aggregator, while setting corresponding semaphore values to indicate that the shared aggregator is being initialized and/or has been initialized. Other applications/drivers can poll the values of the virtual register(s) at the beginning of their own initialization routines to determine whether the shared aggregator has been fully initialized. This approach eliminates explicit synchronization requirements between applications, allowing them to operate independently while maintaining coordinated access to shared aggregator component(s). This approach can be implemented within the serial driver and can operate transparently across different virtual machines, containers, or hypervisor environments that use the same sensors/components connected to the shared aggregator.

At least one aspect relates to one or more processors. The one or more processors can include one or more circuits. The one or more circuits can initialize a serial driver (e.g., I²C driver) comprising a virtual register (e.g., of a virtual I²C device). The one or more circuits can transmit, using a first application, a first serial communication (e.g., initialization signal for aggregator) via the serial driver to configure an aggregator in communication with a plurality of components (e.g., cameras, sensors, other I²C components). The one or more circuits can update, using the first application, the virtual register (e.g., increment semaphore register to indicate initialization is completed) responsive to the aggregator being configured. The one or more circuits can transmit, using a second application (e.g., that accesses multiport operation of initialized aggregator), a second serial communication to at least one of the plurality of components (e.g., to initialize/operate the components) responsive to the virtual register having been updated.

In some implementations, the one or more circuits can initialize the virtual register as corresponding to a virtual device associated with a virtual device address. In some implementations, the one or more circuits can transmit the first serial communication using the virtual device address. In some implementations, the aggregator comprises at least two serial ports. In some implementations, the serial driver comprises an inter-integrated circuit (I²C) driver.

In some implementations, the one or more circuits can execute the first application in a first virtual machine instance and the second application in a second virtual machine instance. In some implementations, the one or more circuits can initialize a second virtual register of the serial driver. In some implementations, the one or more circuits can update, using the first application, the second virtual register (e.g., increment a second register to indicate the aggregator is currently being initialized) prior to transmitting the first serial communication. In some implementations, the plurality of components comprises one or more cameras (e.g., I²C -addressable cameras). In some implementations, the plurality of components comprises one or more display units. In some implementations, the serial driver communicates with the aggregator via a plurality of serial busses.

At least one aspect relates to a system. The system can include a host circuit comprising a serial driver and at least one serial bus, the at least one serial driver comprising a virtual register associated with a corresponding address. The system can include a component circuit comprising an aggregator coupled to the at least one serial bus of the host circuit, the aggregator configured to translate serial communications to instructions for at least one device of the component circuit. The system can transmit a serial communication via the at least one serial bus to configure the aggregator. The system can set the virtual register of the serial driver to a value using the corresponding address responsive to configuring the aggregator.

In some implementations, the system can execute a first application to instruct the serial driver to transmit the serial communication. The system can execute a second application to determine that the aggregator is configured by accessing the virtual register using the corresponding address and instruct the serial driver to communicate with the at least one device responsive to determining that the aggregator is configured. In some implementations, the serial driver can be an I²C driver. In some implementations, the aggregator can comprise a plurality of ports respectively coupled to a plurality of serial buses of the host circuit. In some implementations, the component circuit can comprise a plurality of devices coupled to the aggregator.

At least one aspect is related to a method. The method can include initializing a serial driver comprising at least one virtual register. The method can include transmitting a first serial communication via the serial driver to configure an aggregator in communication with a plurality of components, using a first application. The method can include updating the at least one virtual register responsive to the aggregator being configured, using the first application. The method can include accessing, using a second application, at least one of the plurality of components responsive to the virtual register having been updated, using a second application.

In some implementations, the method can include initializing the virtual register as corresponding to a virtual device associated with a virtual device address. In some implementations, the method can include transmitting the first serial communication using the virtual device address.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a video language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for synchronizing serial drivers using virtual serial registers are described in detail below with reference to the attached drawing figures, wherein:

FIG. 1 is a block diagram of an example system for synchronizing serial drivers using virtual serial registers, in accordance with some embodiments of the present disclosure;

FIG. 2 depicts an example diagram showing an example serial driver implementing virtual devices/registers associated with corresponding address(es), in accordance with some embodiments of the present disclosure;

FIG. 3 is a flow diagram of an example of a method for synchronizing serial drivers using virtual serial registers, in accordance with some embodiments of the present disclosure;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

This disclosure relates to systems and methods for synchronizing independent drivers accessing a shared aggregator through virtualized inter-integrated circuit (I²C) devices and registers. In certain architectures, multiple sensors or components can communicate via a serial communication protocol such as I²C through a single shared aggregator. The aggregator may include multiple I²C ports and can receive the serial data on the I²C bus(es) and can translate the serial data into a format that is compatible with the sensors/components. Each sensor/component can implement different functionality within a computing system and may require rapid initialization for optimal performance.

The different sensors/components that communicate via the shared aggregator may be accessed and/or configured by different applications, sometimes operating in different execution environments (e.g., virtual machines). It is challenging to properly coordinate application execution and sensor/component initialization when independent applications attempt to initialize their respective sensors/components (e.g., cameras, etc.) simultaneously, as the common initialization steps involving power-on, configuration, and video pipeline setup can only be performed once by a single application/driver.

Traditional approaches attempt to address these issues by the application/driver startup sequence, where one application/driver initializes the aggregator first, followed by subsequent applications/drivers after a predetermined delay or using inter-process synchronization mechanisms. These approaches introduce dependencies between application/drivers, potentially hindering flexibility and scalability. For instance, if an application/driver experiences unexpected delays during initialization, it can hold up all subsequent applications/drivers relying on the shared aggregator. Moreover, such approaches are impracticable to implement when applications/drivers are executing in a manner that does not permit inter-process communication, such as isolated virtual machine environments or containers.

The techniques described herein address this challenge by implementing an I²C driver that instantiates a virtual I²C device and associated virtual drivers. The virtual I²C device and associated virtual drivers may be associated with device identifiers and corresponding register addresses in the I²C device/address space. The virtual I²C registers can be used to store data in a manner similar to a software semaphore, enabling synchronization between isolated applications/drivers that access the I²C driver for device communication.

In one example, a first application/driver increments a designated virtual I²C register, functioning as a semaphore, to synchronize the shared aggregator. As the last step in the initialization sequence, the first application/driver can transmit a signal to the I²C driver to update a virtual register of a virtual I²C device, operating as a flag to indicate that the aggregator is ready for use by other applications/drivers. Subsequent applications/drivers can then poll the value of this virtual semaphore register at the beginning of their own initialization routines. When the semaphore register has been incremented, additional applications/drivers can proceed to access the functionality of the shared aggregator. The virtual I²C register therefore effectively prevents concurrent access to the shared aggregator during initialization/configuration.

This approach eliminates explicit synchronization requirements between applications, allowing them to operate independently while maintaining coordinated access to shared aggregator component(s). This approach can be implemented within the I²C driver and can operate transparently across different virtual machines, containers, or hypervisor environments that use the same sensors/components connected to the shared aggregator. These techniques can be implemented in any type of environment that implements shared serial resources, including but not limited to automotive applications.

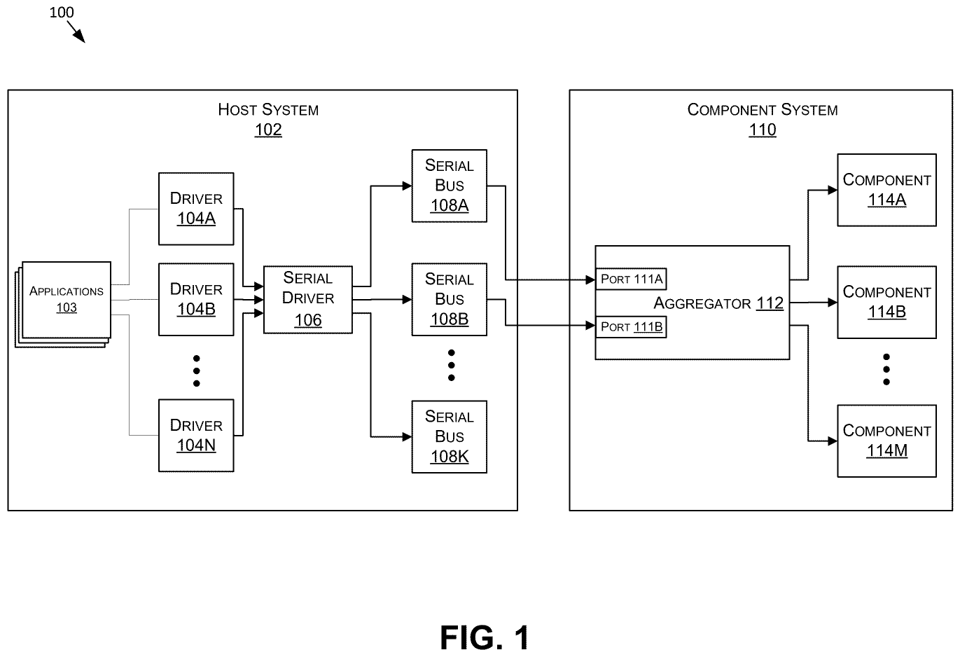

With reference to FIG. 1, FIG. 1 is an example computing environment including a system for synchronizing serial drivers using virtual serial registers, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 can be utilized to synchronize drivers 104A-104N using virtual serial registers stored as part of a serial driver 106. The system 100 is shown as including a host system 102 (sometimes referred to as a “host circuit”) and a component system 110 (sometimes referred to as a “component circuit”). The host system 102 is shown as including one or more applications 103, one or more drivers 104A-104N (sometimes generally referred to as the “driver(s) 104”), at least one serial driver 106, one or more serial buses 108A-108K (sometimes generally referred to as the “serial bus(es) 108”). The component system 110 is shown as including at least one aggregator 112 coupled to one or more components 114A-114M (sometimes referred to as “component(s) 114” or “device(s) 114”). In this example, the aggregator 112 is shown as including multiple ports 111A and 111B (sometimes generally referred to as “port(s) 111”).

The host system 102 can include any type of computing device that can communicate using corresponding serial buses 108. For example, the host system 102 may be a system-on-chip (SoC) device, a microcontroller, a computer, or any other type of computing device that can implement serial communications. The host system 102 can execute one or more applications 103 and/or drivers 104 to communicate with the serial driver 106 to carry out the techniques described herein.

The component system 110 can be any type of computing device that includes components 114 that can operate via serial instructions decoded using an aggregator 112. For example, the component system 110 may be an SoC device, a microcontroller, a computer, or any other type of computing device that can implement serial communications. In the example configuration shown, the host system 102 and the component system 110 are shown as separate devices. However, in some implementations, the host system 102 and the component system 110 may be included as part of a single computing device/system, and may share a common power source, printed circuit board, or other components. In the example configuration shown, the host system 102 can operate as a “master” serial controller, where the serial buses 108 are used to transmit serial commands to the component system 110. The component system 110 can operate as the “slave” serial device, which receives and responds to serial commands via the aggregator 112.

The host controller 102 is shown as including one or more applications 103. The applications 103 can be any type of software executed by the host system 102 that can communicate with the component system 110 via the serial buses 108 to perform one or more operations. In one example, an application 103 may be a camera control application including instructions to manage and control one or more cameras (e.g., components 114) of the component system 110. Furthering this example, the application 103 can receive user inputs to adjust camera settings such as resolution, frame rate, and exposure, and can transmit these settings to the appropriate components 114 through the serial driver 106 and the serial buses 108. Additionally, the application 103 can receive and process data from the cameras, such as image frames, and can perform further processing or analysis on this data and/or store the data for logging purposes.

Different applications 103 may include and/or invoke different drivers 104 corresponding to different components 114. For instance, a temperature sensor application 103 can invoke a driver 104 that includes instructions to communicate with temperature sensors (e.g., one or more components 114), while a camera application 103 can invoke a driver 104 with instructions to communicate with and/or control cameras. In some implementations, the applications 103 can invoke one or more drivers 104 by invoking application programming interfaces (APIs) of the corresponding driver(s) 104 and/or low-level operating system functions of the host system 102.

The host system 102 is shown as including one or more drivers 104. The drivers 104 can be software, hardware, or combinations thereof that can facilitate communication between the host system 102 and the components 114 of the component system 110 via the serial buses 108. The drivers 104 can operate as bridges between the applications 103 (or operating system) of the host system 102 and the serial hardware (e.g., the serial buses 108) of the host system 102. Each of the drivers 104 can include instructions to control one or more of the components 114 of the component system 110. Examples of drivers 104 can include but are not limited to drivers for different types of cameras (e.g., an occupancy monitoring camera (OMC), front looking camera (FLC), etc.) an automotive system, other types of cameras, or any other device/component that can be accessed via serial communications via the serial driver 106.

The drivers 104 can perform various functions, including but not limited to instructing the serial driver 106 to transmit serial commands, and receiving responses from corresponding components 114 via the serial buses 108 and the serial driver 106. In some implementations, the drivers 104 may expose function calls, APIs, or other suitable interfaces to one or more applications 103, to enable the applications 103 to control and/or retrieve data from the components 114 of the component system 110. In some implementations, the drivers 104 and/or the application 103 can transmit instructions to initialize the aggregator 112 of the component system 110, as described in further detail herein. However, it should be understood that the drivers 104 may operate to communicate, configure, or otherwise access any type of device or component 114 via corresponding serial communications. In some implementations, the drivers 104 can also handle error checking and data validation to ensure reliable communication with the components 114. In some implementations, the applications 103 and/or the drivers 104 can be implemented in different virtual machines, containers, or hypervisor environments executing on the host system 102. Although shown as separate from the applications 103, in some implementations, one or more of the drivers 104 can be part of one or more of the applications 103.

The drivers 104 can invoke the serial driver 106 to execute serial commands via the serial buses 108 by utilizing a series of function calls or APIs provided by the serial driver 106. For example, a driver 104 can initiate communications with a corresponding component 114 by calling a function in the serial driver 106 (e.g., instructing the serial driver) to transmit one or more serial commands to a corresponding port 111 of the aggregator 112, which in turn decodes and forwards the command to the corresponding component 114. The drivers 104 may receive data (e.g., response data from read commands, status data, etc.) from the aggregator 112 and/or the components 114 via the serial driver 106.

The host system 102 is shown as including at least one serial driver 106. In one example, the serial driver 106 can be an inter-integrated circuit (I²C) driver. The serial driver 106 can receive and translate instructions from the applications 103 and/or the drivers 104 to low-level serial protocol signals that can be transmitted via the serial bus 108. The serial driver 106 may expose functions, APIs, or other interfaces to drivers 104 and/or applications 103, which the drivers 104 and/or applications 103 can invoke functions to communicate with the components 114. The functionality exposed by the serial driver 106 can include but are not limited to operations specific to the serial protocol implemented by the serial driver 106.

In an example where the serial driver 106 is an I²C driver, the serial driver 106 can handle I²C read and write operations by managing the transmission of start and stop conditions, activating appropriate serial buses 108, addressing appropriate components 114 and/or ports 111 of the aggregator 112, and exchanging data over the serial buses 108, among other operations. The serial driver 106 can manage the state of I²C communications, which may include providing/receiving acknowledgment (ACK) and non-acknowledgment (NACK) signals to ensure that data is correctly received and processed by the aggregator 112 (or components 114) of the component system 110. In some implementations, the serial driver 106 may implement I²C general call operations, which can allow broadcasting commands to multiple components 114 and/or ports 111 of the aggregator 112 simultaneously. The serial driver 106 can also low-level I²C protocol functionality such as clock stretching.

The host system 102 is shown as including the serial buses 108A-108K. The serial buses 108 can include hardware interfaces that can communicate serial commands generated by the serial driver 106 to external serial devices. The serial buses 108 can facilitate the transmission of data between the host system 102 and the component system 110, enabling the host system 102 to control and interact with the components 114 via the aggregator 112. Although the host system 102 is shown as including multiple serial buses 108A-108K, in some implementations, the host system 102 may include any number of serial buses 108. The serial buses 108 can be implemented using physical connections including but not limited to wires or traces on a printed circuit board. The serial buses 108 can be used to implement any type of serial communication protocol.

The serial buses 108 can provide electrical signals to one or more serial devices coupled to the buses, such as the ports 111 of the aggregator 112 and other components 114. The electrical signals can include clock signals, data signals, and/or control signals to implement the serial communication protocol. For example, the serial buses 108 transmit clock signals to synchronize the timing of data transmission and reception, data signals to convey the actual information being communicated, and/or control signals to manage the start and stop conditions of communication sequences. The serial buses 108 can include hardware (e.g., transistors, resistors, logic circuits, etc.) to manage the electrical characteristics of serial communications, such as voltage levels and signal integrity.

In some implementations, the serial buses 108 can implement serial communications by managing the transmission and reception of data in a sequential manner. In an example serial communication protocol, data can be transmitted sequentially bit by bit over a single data line synchronized to clock signal. For example, the serial driver can 106 can initiate a communication sequence by transmitting a start condition via a corresponding serial bus 108, followed by the transmission of address and data bytes, and concluding with a stop condition. In some implementations, the serial buses 108 can manage error detection and correction mechanisms to ensure the integrity of the data being transmitted. In some implementations, the serial buses 108 support various modes of operation, such as full-duplex or half-duplex communication, depending on the serial protocol implemented by the serial driver 106.

The component system 110 is shown as including at least one aggregator 112. The aggregator 112 can include one or more circuits coupled to one or more serial buses 108 of the host system 102. The aggregator 112 can include electrical circuitry (e.g., logic circuits, etc.) that can decode serial signals received from one or more serial buses 108. The aggregator 112 can be implemented using various hardware components, including but not limited to shift registers, clock recovery circuits, and data buffers, to accurately interpret and/or convert incoming serial data into a format that can be communicated to the components 114. The aggregator 112 is shown as including one or more ports 111, each including circuitry to independently receive respective serial communication streams.

In one example, the aggregator 112 can include a multi-port deserializer. The aggregator 112 can receive and translate serial commands and/or data received via the serial buses 108 into a format compatible with one or more corresponding components 114. Upon receiving a serial command, the aggregator 112 can decode the command/data and can extract the relevant information, such as the address of the target component 114 and the data payload. The aggregator 112 can then forward this information to the appropriate component 114 for further processing. The aggregator 112 can handle responses and/or other data received from the components 114 by encoding the data back into a serial format and transmitting it back to the host system 102 via the serial buses 108. The aggregator 112 can include any type of interface to communicate with one or more of the components 114 of the component system 110. In some implementations, the aggregator 112 can include a separate interface for each component 110, or in some implementations, multiple components 114 may share an interface. One example interface that may be implemented by the aggregator 112 can include a gigabit multimedia serial link (GMSL) interface. For example, the aggregator 112 can translate serial commands transmitted via the serial buses 108 into a format compatible with the GMSL interface to communicate the corresponding serial commands/data to the appropriate component. Other interfaces may also be implemented by the aggregator 112.

The aggregator 112 can implement serial communications by managing the synchronization and decoding of serial data streams received via ports 111 from the serial buses. In one example, the aggregator 112 (or ports 111 thereof) can use a clock recovery circuit to synchronize with the clock signal provided by one or more serial buses 108, ensuring that data bits are sampled at the correct times. The aggregator 112 can process the incoming serial data stream received via one or more ports 111 and can convert it into a format that is compatible with the corresponding interface of the addressed component 114. In some implementations, the aggregator may provide/implement a serial address for each component in accordance with the serial protocol (e.g., the I²C protocol), such that the aggregator 112 can automatically map and provide data/commands received from a port 111 to a corresponding interface of the addressed component 114.

In this example, the aggregator 112 is shown as including multiple ports 111, each capable of handling independent serial communication streams, allowing for concurrent processing of multiple serial communications from multiple serial buses 108. In this example, the aggregator 112 is shown as including two ports 111A and 111B, however it should be understood that the aggregator 112 may include any number of ports 111. Each port 111 can be a physical interface coupled to a corresponding serial bus 108 of the host system 102. Each port 111 can include electrical circuitry that can receive and can process serial communication signals transmitted over the serial buses 108. Each port 111 can be implemented using various hardware components, such as transceivers, buffers, and clock recovery circuits, to ensure reliable and accurate data transmission and reception.

Each port 111 can receive serial communications from the corresponding serial bus 108 and can process the incoming data stream. In some implementations, each port 111 can handle the synchronization of the incoming serial data by using clock recovery circuits to align the data bits with the clock signal provided by the serial bus 108. Once synchronized, the ports 111 can extract data and address information from serial communications and can store this information in registers and/or memory elements of the aggregator 112 for processing/conversion, as described herein. In some implementations, the ports 111 can implement hardware-level error detection and correction mechanisms to ensure the integrity of the received data.

Each port 111 can correspond to one or more device addresses and/or register addresses for serial communications. For example, a port 111 can be associated with a specific device address that identifies the target component 114 to which the serial data is intended. The port 111 can be associated with one or more register addresses corresponding to various memory locations, commands, or functionalities of the addressed component 114, allowing the aggregator 112 to translate the data to the corresponding commands and/or data for the addressed component 114. The addresses can be initialized via configuration of the aggregator 112, in some implementations, as described in further detail herein. Implementing one or more device and/or register addresses enables the aggregator 112 to manage multiple components 114 connected to different interfaces of the aggregator 112. The ports 111 can transmit responses from the components 114 that are encoded by the aggregator 112 into a serial format.

The component system 110 is shown as including one or more components 114A-114M. The component system 110 can include any number of components 114. Each component 114 can be any type of device, system, or circuit that can receive commands and/or provide data via corresponding interfaces of the aggregator 112. Non-limiting examples of components 114 can include sensors (e.g., cameras, etc.), actuators, microcontrollers, or any other type of device that can communicate via the aggregator 112 as described herein. In an example where the component system 110 is part of an automotive system, the components 114 can include imaging sensors such as an OMC, an FLC, or other types of cameras. In some implementations, the components 114 can include various other sensors such as temperature sensors, pressure sensors, or environmental sensors. Each component 114 can perform specific functions and can generate and/or process data, such as capturing images, detecting environmental conditions, or controlling mechanical devices/systems, among other functionalities.

The components 114 can perform various functions based on the commands received from the host system 102 via the aggregator 112. For example, a camera component 114 can capture images and transmit the image data back to the host system 102. A temperature sensor component 114 can measure temperature and transmit the temperature data to the host system 102. Each component 114 can include specific registers and memory locations that can be accessed via serial commands to control its operation and retrieve data. The components 114 can include control logic to process incoming commands and generate appropriate responses, which can be transmitted back to the host system 102 via the aggregator 112. In some implementations, the components 114 can be configured to operate in different modes based on the commands received.

The components 114 can operate in connection with the aggregator 112 to facilitate control of the components 114 via serial communications from the host system 102. In some implementations, each component 114 can be associated with a specific device address and/or register addresses that are used to identify and communicate with the component 114. As described herein, when a serial command is transmitted from the host system 102 via the serial buses 108, the aggregator 112 decodes the command and routes it to the appropriate component 114 based on the device address. The component 114 can then receive data corresponding to the command and perform one or more functions, such as modifying a configuration value/setting, activating an external system/device (e.g., an actuator), performing an action such as capturing an image, or returning data (e.g., captured images, sensor readings, status register data, etc.) to the host system 102 via the aggregator 112.

The aggregator 112 can be a configurable component of the host controller 102, which can be configured by the host system 102 via serial communications during a boot process or an initialization process. For example, in a default configuration setting, the aggregator 112 may not necessarily include active both ports 111A and 111B, and instead operate on a single port 111. In another example, the mapping between device/register addresses of the serial protocol to corresponding commands/interfaces/registers of components 114 may be established/initialized/provided as part of the configuration process.

The host system 102 can configure the aggregator 112 using serial communications from one of the applications 103 and/or drivers 104. For example, during initialization of the host system 102 (e.g., during bootup, in response to a reset signal, in response to a configuration signal from an external device, etc.), the applications 103 can communicate one or more serial signals to modify configuration settings of the aggregator 112. For example, the serial communications may include signals to initialize and/or configure the aggregator 112 to use multiple ports 111 for parallel serial communications, establish one or more device and/or register addresses for the components 114, configure clock speeds or other operating characteristics of the serial communications, and/or modify other operational characteristics of the aggregator 112.

To synchronize the initialization/configuration of the aggregator 112 among multiple applications 103 and/or drivers 104 of the host system 102, the serial driver 106 can implement one or more virtual registers. These virtual devices can be instantiated within the serial driver 106 and can be associated with specific device identifiers and register addresses within the serial device/address space. The virtual devices can act as intermediaries between the applications 103 and drivers 104 and the aggregator 112, enabling coordinated access to the aggregator 112 during initialization and configuration processes. Each virtual device can include one or more virtual registers that can be used to store synchronization data, such as flags or semaphores, to manage concurrent access to the aggregator 112.

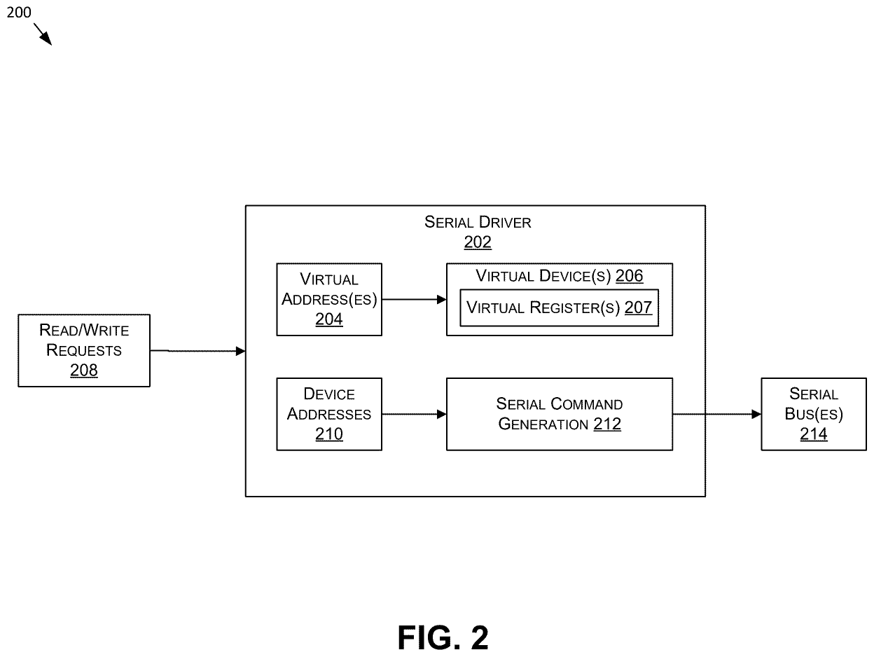

In one example, a first application 103 (or driver 104) can increment a designated virtual semaphore register to indicate that it is in the process of initializing the aggregator 112 and can increment a second virtual semaphore register to indicate that the aggregator 112 has been initialized. Subsequent applications 103 or drivers 104 can then poll the value of the second virtual semaphore register to determine whether the aggregator 112 is ready for use. In another example, a primary application 103 and/or driver 104 can automatically commence initialization/configuration of the aggregator 112, and automatically update a virtual semaphore register upon completing initialization/configuration. When the semaphore register has been incremented, additional applications 103 or drivers 104 can proceed to access the functionality of the aggregator 112. This approach effectively prevents concurrent access to the aggregator 112 during initialization and configuration, ensuring that each application 103 or driver 104 can operate independently while maintaining coordinated access to the shared aggregator 112. An example representation of the virtual devices/registers are described in connection with FIG. 2.

Although the techniques described in connection with the system 100 relates to the configuration and coordination of access to an aggregator 112, the techniques described herein are not limited thereto. The techniques described herein can be applied to coordinate access to any type of shared serial device or component, including but not limited to serializers, memory devices (e.g., EEPROM, etc.), power management devices (e.g., power management integrated circuits (PMICs), etc.), sensors (e.g., temperature sensors), or other types of serial devices/components. The serial driver 106 can implement virtual devices/registers to synchronize and manage concurrent access to any number or type of serial devices, ensuring that multiple applications and/or drivers can operate independently while maintaining coordinated access to shared serial resources.

For example, the serial driver 106 can be implemented in any arrangement where multiple clients (e.g., drivers, applications, etc.) require arbitration for access to a single shared serial resource. In such implementations, the serial driver 106 can manage and synchronize the interactions between the multiple clients and the shared serial resource, ensuring that concurrent access is properly coordinated, and conflicts are avoided. Further, while the configuration of a multiport aggregator 112 serves as one example use case, the serial driver 106 described herein can be used to coordinate access via a single-port aggregator 112 or any other type of single-or multi-port serial device.

Referring to FIG. 2, illustrated is an example diagram 200 showing an example serial driver 202 implementing virtual device(s) 206 and corresponding virtual register(s) 207 associated with virtual address(es) 204, in accordance with some embodiments of the present disclosure. The serial driver 202 can be similar to and include any of the structure of and implement any of the functionality of the serial driver 106 of FIG. 1. The serial driver 202 can expose one or more virtual addresses 204 and/or one or more device addresses 210 to applications/drivers accessing the serial driver 202. The device addresses 210 can be specific identifiers within the serial address space that correspond to physical devices coupled to one or more serial buses (e.g., the serial buses 214). These device addresses 210 can be used to identify and communicate with specific components connected to the serial device via the serial protocols (e.g., I²C, etc.) implemented by the serial driver 202.

The virtual addresses 204 can point to virtual devices 206 and/or corresponding virtual registers 207, which can be used to manage synchronization and coordination among multiple applications and drivers. For example, a virtual address 204 can point to a virtual semaphore register 207 that is used to indicate the status of the aggregator during initialization/configuration. The virtual addresses 204 can be initialized by the serial driver 202 during bootup, reset, or via a configuration signal, and can occupy portions of the serial address space that are least likely to have physical devices, such as the highest address values. This ensures that the virtual addresses 204 do not conflict with the addresses of actual physical devices. In a specific serial communication protocol such as I²C, a virtual address 204 can be assigned to a virtual I²C device, which can include virtual registers 207 to manage synchronization flags. These virtual registers 207 can be used to ensure that only one application or driver initializes the aggregator at a time, preventing concurrent access and potential conflicts.

The serial driver 202 can automatically instantiate one or more virtual devices 206 and/or virtual registers 207 in memory of the serial driver 202. Each virtual device 206 can include or otherwise be associated with one or more virtual registers 207 that are used to manage synchronization and coordination among multiple applications and drivers. In some implementations, multiple sets of virtual devices 206 and/or virtual registers 207 may be instantiated for different devices that are to be initialized according to the techniques described herein. For example, each virtual device 206 and/or virtual register 207 can be associated with a specific device identifier of a corresponding physical device for which initialization is managed using the virtual device 206 and/or virtual register 207. These virtual registers 207 can store synchronization flags, status information, and other data that can be used to coordinate access to the physical device.

The virtual devices 206 and virtual registers 207 can be used to ensure that multiple applications and drivers operating in different virtual machines, containers, or execution environments can access corresponding physical devices (e.g., the aggregator 112) without conflict. By implementing virtual devices 206 and virtual registers 207 within the serial driver 202, the serial driver 202 can manage the synchronization of initialization and configuration processes across different applications and drivers outside of containerized execution environments. This approach eliminates the need for explicit synchronization between applications and drivers, allowing them to operate independently while maintaining coordinated access to any number of physical components or devices.

In this example, the serial driver 202 can receive read/write requests 208. The read/write requests 208 can be requests to read or modify registers 207 defined in the serial address space exposed by the serial driver 202. The read/write requests 208 can be provided via one or more applications (e.g., applications 103) and/or drivers (e.g., drivers 104). In one example, the read/write requests 208 can be identify a virtual address 204 of a virtual device 206 and/or register 207. The read/write requests 208 can be processed by the serial driver 202, which can automatically use the specified virtual addresses 204 to access the corresponding virtual registers 207 stored in memory. For example, a read request can be directed to a specific virtual address 204, and the serial driver 202 can retrieve the value stored in the corresponding virtual register 207 and return it to the requesting application or driver. Similarly, a write request can be directed to a specific virtual address 204, and the serial driver 202 can update the value stored in the corresponding virtual register 207 based on the data provided in the request. In some implementations, the serial driver 202 may include a queue, buffer, or other data structure that can maintain multiple requests transmitted from different applications/drivers.

In another example, the serial driver 202 can receive a read/write request 208 for a physical device. For example, the read/write request 208 can identify a device address 210 of a physical device connected to one of the serial buses 214 (e.g., a serial bus 108). The read/write request 208 can be initiated by an application or driver that needs to communicate with a specific physical device, such as a camera, sensor, actuator, or any other type of device that can implement serial communications (e.g., one or more ports 111 of the aggregator 112 of FIG. 1, etc.). The serial driver 202 can process the read/write request 208 using a serial command generation process 212 to generate a serial command that includes the device address 210 and the specific data or command intended for the physical device.

The serial command generation process 212 can format the request 208 into a serial command that adheres to the appropriate serial communication protocol (e.g., I²C, etc.) implemented by the serial driver 202. For example, if the request 208 is a read operation, the serial driver 202 can generate a serial command that includes the device address 210 and the register address of the data to be read. If the request 208 is a write operation, the serial driver 202 can generate a serial command that includes the device address 210, the register address of the data to be written, and the data itself. Once the serial command is generated, the serial driver 202 can transmit the command via one or more serial buses 214 to the physical device, as described herein. The physical device can then process the command and can return any requested data back to the serial driver 202, which can then relay the data to the requesting application or driver. By implementing these techniques, the serial driver 202 can automatically process requests for both virtual and physical devices and registers using a common interface to any number of applications/drivers.

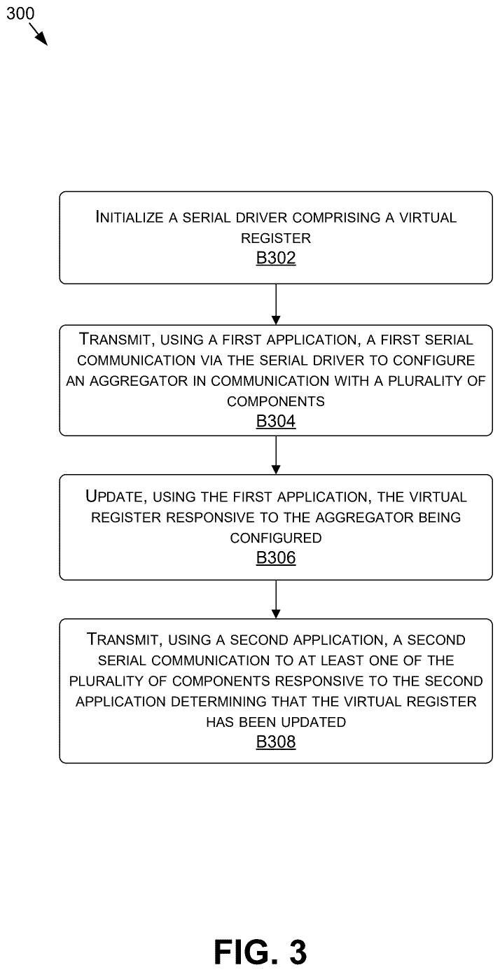

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for synchronizing serial drivers using virtual serial registers. The method 300, at block B302, includes initializing a serial driver (e.g., serial driver 106, serial driver 202, etc.) comprising at least one virtual register (e.g., virtual register 207). In some implementations, the virtual registers and/or devices described herein may be implemented by corresponding hardware registers of the serial driver. For example, the serial driver may implement and/or access one or more hardware registers (e.g., debug registers) of a host system (e.g., the host system 102) or one or more hardware registers of a component system (e.g., the component system 110) or components thereof (e.g., the component(s) 114). Initializing the serial driver may include executing instructions of the serial driver to allocate memory to store values of the virtual registers. The initialization of the serial driver may include generating one or more virtual addresses for a virtual device corresponding to the virtual register, in accordance with the serial protocol (e.g., the I²C protocol) implemented by the serial driver. Depending on the serial protocol, in some implementations, a virtual device address may not necessarily be implemented, and instead a virtual address for the virtual device in the serial address space can be automatically allocated. The virtual address may be selected as a value that is unlikely to be occupied by a physical device, such as a large address value. In some implementations, multiple virtual devices and/or addresses can be allocated to accommodate synchronization/initialization of multiple components (e.g., multiple aggregators, etc.). The virtual registers may be initialized to a default value (e.g., a zero value, etc.).

The method 300, at block B304, includes transmitting, using a first application (e.g., application 103) and/or driver (e.g., driver 104), a first serial communication (e.g., one or more read/write requests) via the serial driver to configure a aggregator (e.g., the aggregator 112) in communication with one or more components (e.g., the components 114). Configuring the aggregator can include modifying configuration settings of the aggregator. For example, the serial communications may include signals to initialize and/or configure the aggregator to use multiple ports (e.g., ports 111) for parallel serial communications, establish one or more device and/or register addresses for the components, configure clock speeds or other operating characteristics of subsequent serial communications, and/or modify other operational characteristics of the aggregator. The applications and/or drivers can configure the aggregator on bootup, in response to a reset signal, or in response to a variety of other signals, in some implementations.

The method 300, at block B306, includes updating, using the application and/or driver, the virtual register responsive to the aggregator being configured. The application and/or driver may transmit a sequence of commands to initialize/configure the aggregator. The application and/or driver can monitor progress of the initialization/configuration of the aggregator by confirming acknowledgement messages from the aggregator and/or reading register values of the aggregator via serial communications. The application and/or driver can use the serial communications to determine whether the aggregator has been fully initialized/configured according to instructions of the application and/or driver. If the aggregator has been initialized/configured, the application and/or driver can transmit a write request to the serial driver to modify (e.g., increment, set to a predetermined value, etc.) at least one virtual register of the serial driver. The virtual register may be accessed using the virtual address of the virtual device instantiated by the serial driver.

In some implementations, one or more virtual registers may be updated using similar approaches to reflect the progress of initializing/configuring one or more aggregators and/or other components shared among multiple applications. For example, a first virtual register may be updated to reflect that a aggregator and/or component is being initialized, and a second virtual register may be updated in response to determining that the aggregator and/or component has completed initialization/configuration. Multiple virtual registers and/or virtual devices may be provided to synchronize initialization/configuration for multiple aggregators or serial devices.

The method 300, at block B308, includes transmitting, using a second application (e.g., another application 103 and/or driver 104), a second serial communication to at least one of the plurality of components responsive to the virtual register having been updated. As described herein, the virtual register can operate as a semaphore indicating when aggregators and/or other components have been initialized. Other applications and/or drivers may poll the virtual register to determine whether a corresponding aggregator and/or component have been initialized, and if it has been initialized. If the aggregator and/or component has been initialized, the second application/driver can begin transmitting serial communications via the initialized/configured aggregator to perform various operations. Otherwise, if the aggregator and/or component has not yet been initialized, the application/driver can wait until initialization has been completed (e.g., as indicated by the value of the virtual register).

The systems and methods described herein may be used for a variety of purposes, by way of example and without limitation, for circuit layout definition, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models - such as one or more large language models (LLMs), one or more small language models (SLMs), systems for performing light transport simulation, systems for performing collaborative content creation for 3D assets, systems implemented at least partially using cloud computing resources, and/or other types of systems.

### Example Computing Device

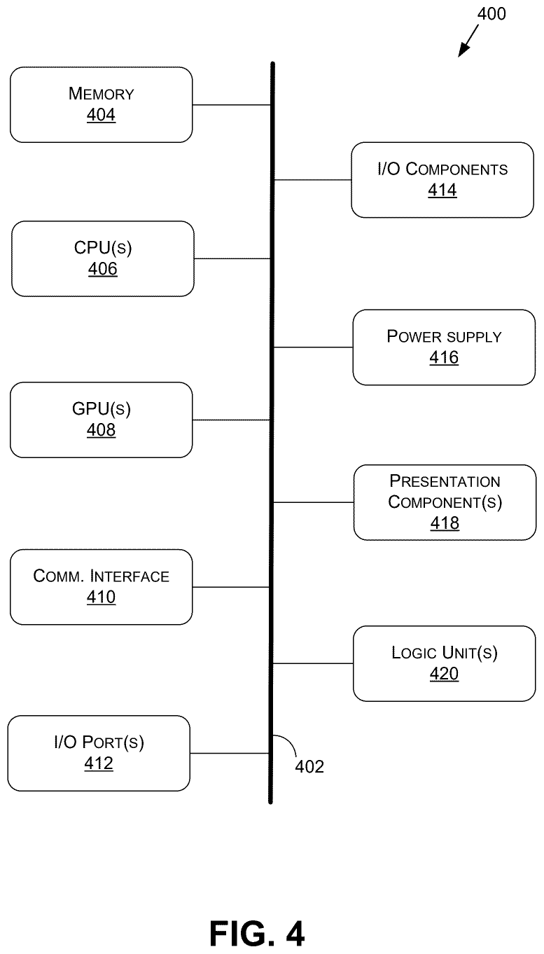

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or buses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

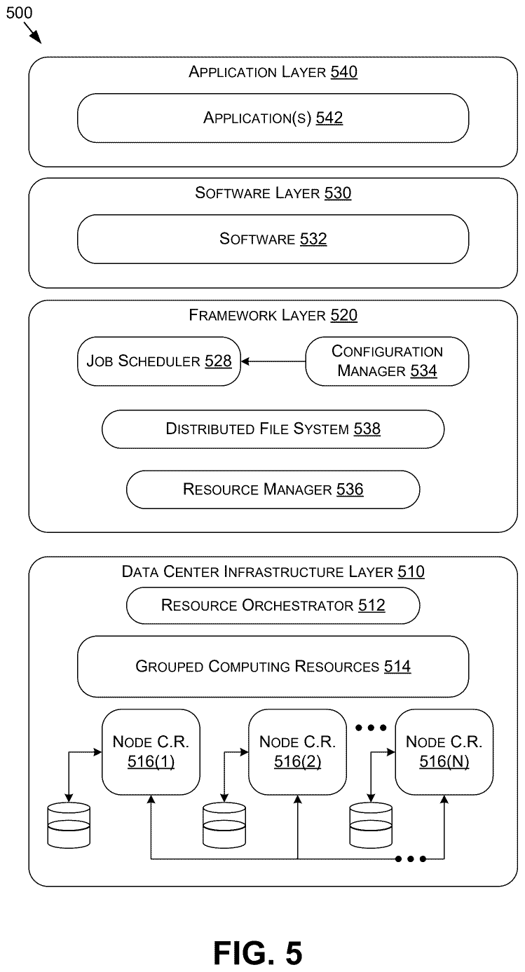

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4 - e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments - in which case a server may not be included in a network environment - and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
initialize a serial driver comprising a virtual register;
transmit, using a first application, a first serial communication via the serial driver to configure a shared resource in communication with a plurality of components;
update, using the first application, the virtual register responsive to the shared resource being configured; and
transmit, using a second application, a second serial communication to at least one of the plurality of components responsive to the virtual register having been updated.

2. The one or more processors of claim 1, wherein the one or more circuits are to:
initialize the virtual register as corresponding to a virtual device associated with a virtual device address.

3. The one or more processors of claim 2, wherein the one or more circuits are to:
transmit the first serial communication using the virtual device address.

4. The one or more processors of claim 1, wherein the shared resource comprises an aggregator having at least two serial ports.

5. The one or more processors of claim 1, wherein the serial driver comprises an inter-integrated circuit (I²C) driver.

6. The one or more processors of claim 1, wherein the one or more circuits are to:
execute the first application in a first virtual machine instance and the second application in a second virtual machine instance.

7. The one or more processors of claim 1, wherein the one or more circuits are to:
initialize a second virtual register of the serial driver; and
update, using the first application, the second virtual register prior to transmitting the first serial communication.

8. The one or more processors of claim 1, wherein the plurality of components comprises one or more cameras.

9. The one or more processors of claim 1, wherein the plurality of components comprises one or more display units.

10. The one or more processors of claim 1, wherein the serial driver communicates with the shared resource via a plurality of serial buses.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a small language model (SLM);
a system for performing generative AI operations using a large language model (LLM);
a system for performing generative AI operations using a video language model (VLM);
a system for performing generative AI operations using a multimodal language model;
a system for generating synthetic data;
a system incorporating one or more virtual machines (VMs);
a system implemented at least partially in a data center; or
a system implemented at least partially using cloud computing resources.

12. A system, comprising
a host circuit comprising a serial driver and at least one serial bus, the serial driver comprising a virtual register associated with a corresponding address; and
a component circuit comprising an aggregator coupled to the at least one serial bus of the host circuit, the aggregator configured to translate serial communications to instructions for at least one device of the component circuit,
wherein the host circuit is to:
transmit a serial communication via the at least one serial bus to configure the aggregator; and
responsive to configuring the aggregator, set the virtual register of the serial driver to a value using the corresponding address.

13. The system of claim 12, wherein the host circuit is to:
execute a first application to instruct the serial driver to transmit the serial communication; and
execute a second application to:
determine that the aggregator is configured by accessing the virtual register using the corresponding address, and
instruct the serial driver to communicate with the at least device responsive to determining that the aggregator is configured.

14. The system of claim 12, wherein the serial driver is an I²C driver.

15. The system of claim 12, wherein the aggregator comprises a plurality of ports respectively coupled to a plurality of serial buses of the host circuit.

16. The system of claim 12, wherein the component circuit comprises a plurality of devices coupled to the aggregator.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a small language model (SLM);
a system for performing generative AI operations using a large language model (LLM);
a system for performing generative AI operations using a video language model (VLM);
a system for performing generative AI operations using a multimodal language model;
a system for generating synthetic data;
a system incorporating one or more virtual machines (VMs);
a system implemented at least partially in a data center; or a system implemented at least partially using cloud computing resources.

18. A method, comprising:
initializing a serial driver comprising at least one virtual register;
transmitting, using a first application, a first serial communication via the serial driver to configure an aggregator in communication with a plurality of components;
updating, using the first application, the at least one virtual register responsive to the aggregator being configured; and
accessing, using a second application, at least one of the plurality of components responsive to the virtual register having been updated.

19. The method of claim 18, further comprising:
initialize the at least one virtual register as corresponding to a virtual device associated with a virtual device address.

20. The method of claim 19, further comprising:
transmitting the first serial communication using the virtual device address.
